(19) United States
(12) Patent Application Publication
(10) Pub. No.: US 2015/0369377 A1
(43) Pub. Date: Dec. 24, 2015

(54) GLAND AND PACKING ASSEMBLY FOR BALL VALVE AND ASSOCIATED PROCESS OF ASSEMBLY

(71) Applicant: SSP Fittings Corp., Twinsburg, OH (US)

(72) Inventors: Stuart Noble, Amherst, OH (US); Adam Zane, Rocky River, OH (US); Terrance W. Holder, Chagrin Falls, OH (US)

(73) Assignee: SSP Fittings Corp.

(21) Appl. No.: 14/742,216

(22) Filed: Jun. 17, 2015

Related U.S. Application Data
(60) Provisional application No. 62/015,071, filed on Jun. 20, 2014.

(51) Int. Cl. F16K 5/06; B23P 15/00

(52) U.S. Cl. CPC F16K 5/0663; B23P 15/001

(57) ABSTRACT

A valve assembly and associated assembly method includes a housing receiving a valve member for movement between open and closed positions. A packing received around the valve member has at least first and second openings in a sidewall thereof and a third opening that has an original unstretched opening dimension smaller than a cross-sectional dimension of the valve member forcibly inserted through the third opening and thereby enlarges the third opening to a stretched opening dimension. A packing gland engages the packing, and at least one of the packing gland and packing has a non-planar surface that urges the stretched opening dimension of the third opening of the packing toward the original unstretched dimension after the valve member is assembled in the packing.

### BACKGROUND

This application claims the priority benefit of U.S. Provisional Application Ser. No. 62/015,071, filed on Jun. 20, 2014, the disclosure of which is incorporated herein by reference.

The present disclosure relates to a valve or valve assembly, and more particularly to a ball valve and an associated process of manufacture and assembly. Of course selected aspects may be applicable to related environments and applications that encounter similar issues resolved by the present disclosure.

It is desirable to provide a packing around a valve or ball member received in a cavity of a housing. Generally speaking, the structure and operation of these types of ball valves are well known to one of ordinary skill in the art.

It is desirable to form the packing as a homogenous, unitary, single, or one-piece packing that has a generally cylindrical configuration, for example, which closely matches the generally cylindrical configuration of a cavity formed in a valve body. The cavity receives a ball member and the packing therein. The packing has an opening in an upper portion that accommodates the ball member and an associated stem through the upper portion of the packing. In addition, multiple openings are provided in a sidewall of the packing for communication with various flow passages formed in the valve body. Further, an opening is typically provided in a lower portion of the packing to accommodate a trunnion below the ball member.

In some instances, it has been proposed to overmold the packing on the ball member. In other instances, the packing is formed and the ball valve is assembled by press fitting or inserting the ball member through an opening in the packing. The ball member is forced through an opening in the packing, for example through an opening provided in the packing, and an interior of the packing has a conformation that closely matches the outer shape of the ball member. The opening is smaller than the ball member, and as a result, the packing material is deformed to accommodate the ball member through the opening. In smaller sized ball valves, the material that forms the packing has sufficient resilience that the packing naturally returns to its original shape. In larger sized ball valves, the packing is stretched to such an extent that the packing does not sufficiently spring back to its original shape and the packing remains at least partially plastically deformed around the opening used for insertion of the ball member into the interior cavity of the packing after insertion of the ball member therein. It is desirable that the packing be closely received around the ball member in order to provide a desired sealing with an external surface of the ball member and trunnions (usually an upper trunnion and a lower trunnion that are integrally formed with the ball member, and the actuating stem).

This deformation of the packing resulting from inserting the ball member into the packing also makes it difficult to insert the ball member/packing subassembly into the housing cavity, and initially inserting the packing into the valve body cavity and subsequently trying to insert the ball member into the packing is not feasible. Thus, the inability of the packing to adopt or spring back to its original shape prior to installation/assembly of the ball member therein results in insufficient, desired sealing with the ball member. Accordingly, a need exists for an improved assembly and process of assembling the ball valve that overcomes these problems and others.

### SUMMARY

A valve assembly includes a single piece packing received about a valve member. A structural arrangement is provided for urging the packing toward sealing engagement with the valve member, namely a trunnion portion thereof.

The valve assembly includes a housing having at least first and second flow passages that communicate with a cavity. A valve member is received in the housing cavity and adapted for selective rotation relative to the housing between open and closed positions. The packing received around the valve member has at least first and second openings that communicate, respectively, with the at least first and second flow passages in the housing. A third opening in the packing has an original unstretched opening dimension smaller than a cross-sectional dimension of the valve member, and a stretched opening dimension resulting from forcibly inserting or directing the valve member through the third opening. The valve assembly further includes a packing gland that operatively engages the packing and has a non-planar surface that urges the stretched opening dimension of the third opening of the packing toward the original unstretched dimension of the third opening after the valve member is assembled in the packing. The non-planar surface urges the stretched opening dimension of the third opening of the packing toward the original unstretched dimension after the valve member is assembled in the packing.

In one arrangement, the non-planar surface includes one of a protrusion on the packing gland and/or a groove on the packing.

The protrusion is located around the third opening in the packing.

The protrusion is continuous around the third opening.

The protrusion has one of a number of non-planar configurations including a tapered or angled surface, radiused surface, a generally U-shaped or V-shaped cross section, etc.

The packing is a single piece, and the valve member includes a spherical ball portion.

The valve member includes a stem extending outwardly through the packing.

A method of assembling a valve assembly includes a housing having a cavity with at least first and second flow passages that communicate with the cavity. A valve assembly is rotatably received in the housing cavity. A packing is received around the valve member and has first and second openings that communicate with the first and second flow passages, respectively. The assembly method includes inserting the valve member into a small dimensioned third opening of the packing whereby the packing is forcibly stretched to accommodate the valve member through the opening. The method further includes inserting the packing the valve member therein into the housing cavity, and installing a gland with the protrusion extending therefrom into operative engagement with the packing around the opening.

The method further includes providing a continuous protrusion extending from the gland into operative engagement with the packing around the third opening.

The method may also include advancing the packing with the valve member inserted therein through a sizing die before inserting the packing with the inserted valve member into the housing cavity.

A primary advantage of the present disclosure is the ability to effectively seal around the valve member.

Another benefit resides in the ability to re-form the packing, particularly in larger sized valve assemblies, where the packing has been stretched during assembly.

Yet another advantage resides in the ability to urge the packing toward its original conformation and eliminate a potential leak path.

Still other benefits and advantages of the present disclosure will become more apparent from reading and understanding the following detailed description.

### BRIEF DESCRIPTION OF THE DRAWINGS

FIG. 1 is a longitudinal cross-sectional view through the valve assembly according to the present disclosure.

FIG. 2 is an enlarged view of the encircled region of FIG. 1.

FIG. 3 is a perspective view of a packing used in the valve assembly of FIG. 1.

FIG. 4 is an elevational view of the packing of FIG. 3.

FIG. 5 is a top plan view of the packing of FIG. 3.

FIG. 6 is a cross-sectional view taken generally along the lines 6-6 of FIG. 4.

FIG. 7 is an enlarged view of the encircled region of FIG. 6.

FIG. 8 is a plan view of a packing gland according to the present disclosure.

FIG. 9 is a cross-sectional view of the packing gland of FIG. 8 taken generally along the lines 9-9 thereof.

FIGS. 10 and 11 are alternate embodiments of the packing gland.

FIGS. 12-14 illustrate other solutions for urging the packing toward an original, unstretched shape after inserting the ball member through a lower surface or bottom of the packing.

### DETAILED DESCRIPTION

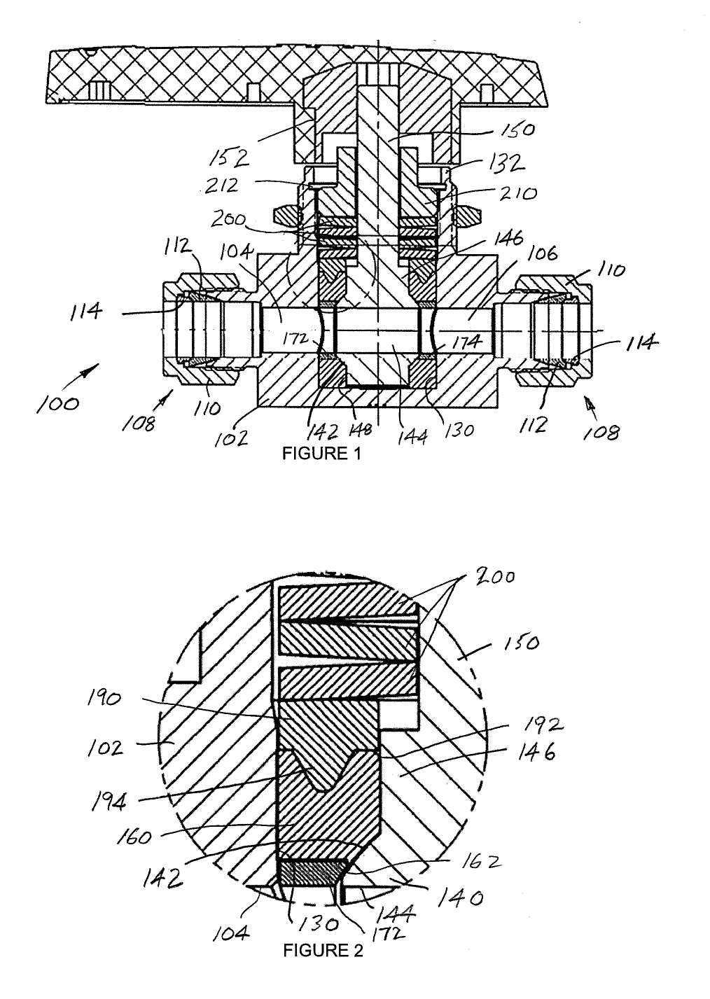

Turning to FIGS. 1-2, there is shown a valve or valve assembly 100, particularly a ball valve assembly, that includes a valve housing or valve body 102 typically formed of a suitable material such as stainless steel. The valve body 102 is shown with at least first and second fluid passages 104, 106, although a greater number of fluid passages may also be formed in the valve body. A fitting assembly 108 is preferably associated at each end of the fluid passages 104, 106 of the valve body 102 in order to interconnect with fluid lines (not shown) of an associated fluid system (not shown). More particularly, the fitting assembly 108 includes a nut 110 threadedly received on the valve body 102 around the fluid passages so that upon tightening the nut relative to the valve body, first and second ferrules 112, 114 grippingly and sealingly engage the associated fluid line in a manner well known to one skilled in the art.

The valve body 102 further includes a cavity 130, and the first and second fluid passages 104, 106 communicate therewith. It is common to machine the cavity 130, for example as a closed end bore shown here as extending inwardly from a surface such as upper surface 132. A valve member 140 is received in the cavity 130. More specifically, the valve member 140 is shown in this embodiment as a ball member having a generally spherical outer surface portion 142. The ball member 140 includes a passage 144 therethrough that selectively communicates with one or both of the at least first and second passages 104, 106 of the valve body 102. First (upper) and second (lower) trunnions 146, 148 are integrally formed as a part of the ball member 140. Likewise, actuating stem 150 is also preferably formed as a part of the one-piece ball member 140 that includes the spherical surface portion 142 having a passage 144 between the upper and lower trunnions 146, 148. The stem 150 preferably has an elongated axial dimension that allows the stem to extend outwardly from the valve body 102, i.e., beyond the upper surface 132 of the valve body 102, for connection with a handle 152 or alternative actuating mechanism (not shown) that selectively rotates the ball member. In this manner, passage 144 in the ball member 140 selectively communicates with one or more of the at least first and second fluid passages 104, 106. For example, as shown in FIG. 1, passage 144 is aligned with the fluid passages 104, 106 to allow communication through the valve assembly 100. Alternatively, the passage 144 can be rotated (e.g. for example through 90°) to position the passage 144 substantially perpendicular to the passages 104, 106 and prevent fluid communication between the fluid passages. Of course if an additional passage(s) (not shown) is provided in the valve body, then selective rotation of the ball member 140 will permit/preclude fluid communication between one or more fluid passages as desired.

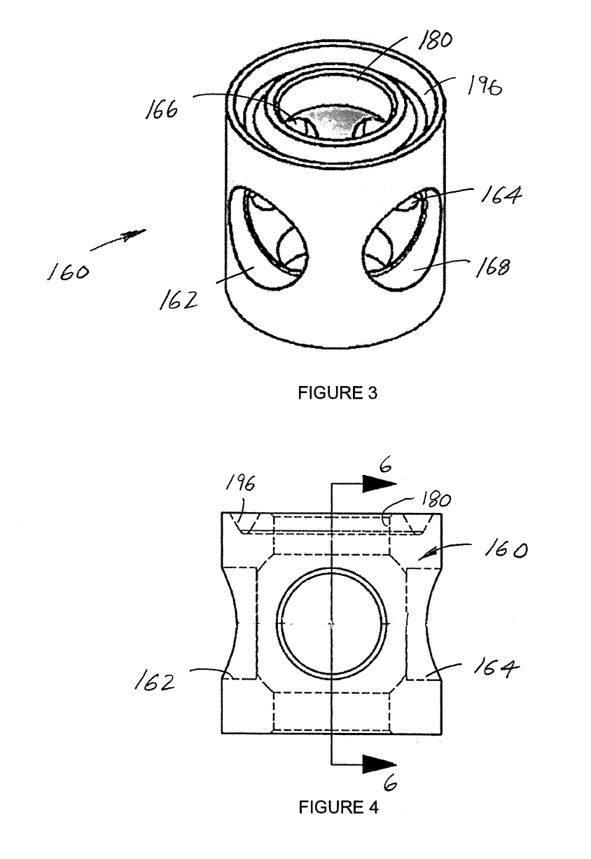

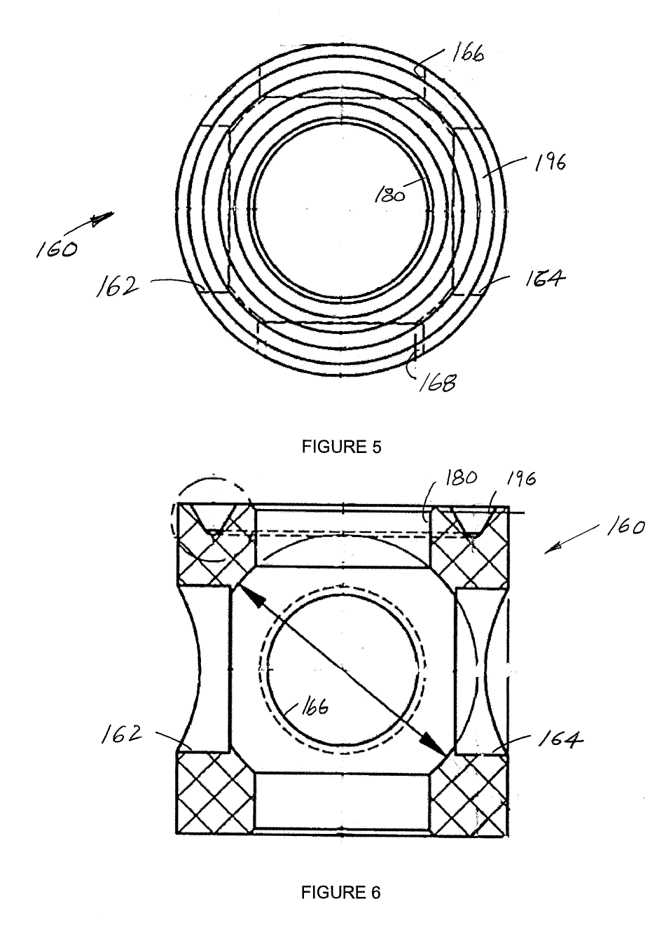

In addition, a packing 160 (see also FIGS. 3-7) is received around the ball member 140, particularly around the outer surface portion 142 and the first and second trunnions 146, 148. The packing 160 has an outer dimension that is substantially identical to that of the valve body cavity 130 in which the packing is received. Typically, the packing 160 is formed of a plastic or polymeric material such as a modified polytetrafluoroethylene (PTFE). Another material that has similar material properties may be used for the packing 160 without departing from the scope and intent of the present disclosure. The material is selected, for example, because of one or more various conditions that the packing 160 may be exposed to such as chemical, pressure, and/or temperature considerations.

Suitable first and second openings 162, 164 are provided in the packing 160 for communication with the first and second passages 104, 106 of the valve body 102. Moreover, these openings 162, 164 are typically slightly enlarged in order to accommodate or receive reinforcement rings 172, 174 (FIGS. 1-2), respectively, that prevent extrusion of the polymeric packing into the passages 104, 106 which could potentially interfere with operation of the ball member 140. Similarly, additional openings 166, 168 (FIG. 6) can be provided in the sidewall of the packing 160 and receive solid disks (not shown) that have a greater rigidity and strength than the polymeric material of the packing, and therefore are more resistant to pressure forces than the packing.

A third opening 180 (recognizing that there may be additional openings that receive the disks as described above) is provided in the packing 160. Shown here, the third opening 180 is provided in the upper surface of the packing 160. The third opening 180 has an original, unstretched opening dimensioned smaller than a cross-sectional dimension of the ball member 140, and more specifically the spherical outer surface portion 142 thereof. The ball member 140 is forcibly inserted through the third opening 180. This stretches and enlarges the third opening 180 to a stretched, opening dimension that is greater than the original, unstretched dimension. For example, the lower trunnion is 148 is initially inserted into the third opening 180. As the lower trunnion 148 and the ball member 140 are advanced through the third opening 180, the material of the packing stretches around the third opening. With smaller ball valve assemblies, the packing 160 is stretched yet exhibits sufficient resilience that the packing (particularly around the third opening) returns to its original shape. However, with larger ball valve assemblies, it has been discerned that the packing 160 does not have sufficient resilience or the extent of stretching is such that the stretched packing material does not return to its original shape, or does not sufficiently return to shape. Unfortunately this leads to the potential that the packing 160 does not seal sufficiently, for example, around the ball member 140 or upper trunnion 146. A potential leak path develops as a consequence and the ball valve may not satisfy desired physical properties.

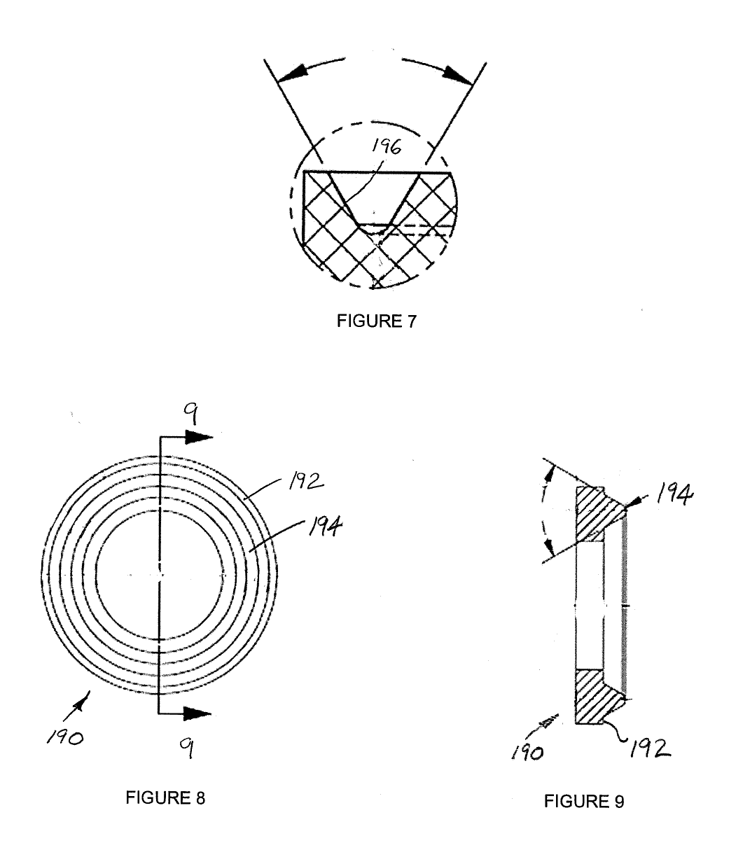

To counteract this sealing problem, the present disclosure uses a modified packing gland 190 (FIGS. 1, 2, 8, and 9) and/or packing 160 (FIGS. 3-7). More specifically, packing gland 190 has a non-planar surface 192 that faces the packing 160 (FIG. 2). The surface 192 includes a protrusion 194 that extends outwardly from the remainder of the packing gland surface. The protrusion 194 has one of a variety of non-planar configurations including, for example, a substantially U-shaped or V-shaped cross-section (FIG. 2) with a rounded vertex. The protrusion 194 is preferably circumferentially continuous, and is positioned around the third opening 180. Likewise, a similarly dimensioned recess 196 (FIG. 7) is provided in the upper surface of the packing 160 to receive the protrusion 194. The recess 196 could be essentially a mirror image of the protrusion 194 (i.e., substantially V-shaped in cross-section with a rounded vertex) to receive the protrusion therein. When the packing gland 190 is urged by Belleville washers 200, for example, toward the packing 160, a sufficient force is imposed on the packing 160 that urges or directs a portion of the packing material around the third opening 180 toward the ball member 140, namely toward the upper trunnion 146 to improve the sealing capability in this region. In response to an axial force imposed on the packing gland 190, the protrusion 194/recess 196 pushes or urges the packing 160 toward the trunnion 146/ball member 140 and improves the sealing capabilities of the packing.

A packing nut 210 is received in the cavity 130 and a retainer such as snap ring 212 (FIG. 1) locates the packing nut in the cavity 130 to impose a preselected force against the washers 200, and consequently impose a preselected force against the packing gland 190. Of course alternative structures can be used to provide the desired force to the packing 160 particularly in this region around the third opening 180 without departing from the scope and intent of the present disclosure.

Typically the ball member 140 is initially inserted into the packing 160 prior to inserting the packing into the valve body cavity 130. As a result of this initial assembly step, and in addition to the inadequate resilience and need for using the preselected force to urge the packing 160 toward its original shape, it may also be necessary to reshape the outer conformation of the packing prior to insertion of the subassembly of the ball member 140 and packing into the valve body cavity 130. If necessary, the subassembly of the ball member 140 and packing 160 is re-sized, for example by passing the subassembly through a sizing die (not shown). Subsequently, the reinforcing rings 172, 174 or reinforcing disks are inserted into the associated openings 162, 164 in the packing, and the re-sized subassembly then inserted into the valve body cavity 130.

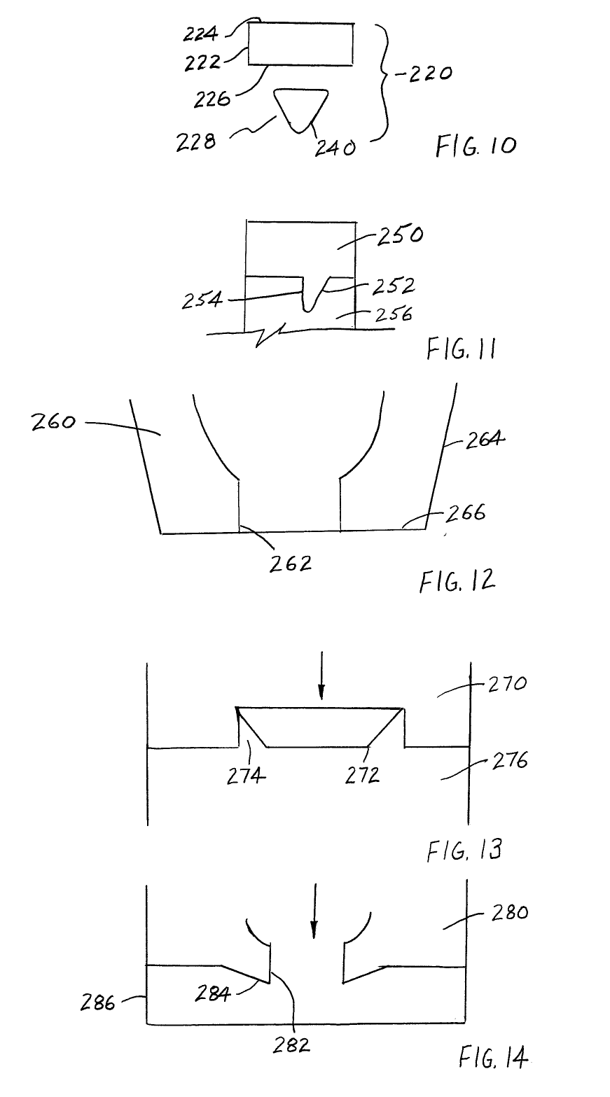

One skilled in the art will recognize that alternative arrangements may be used, some of which are illustrated in FIGS. 10-14. By way of non-limiting example, packing gland 220 is a two-part assembly in which a first portion 222 is a generally annular ring having opposed, first (upper) and second (lower) planar faces 224, 226. A second portion 228 of the two-part packing gland assembly 220 has at least one non-planar face 240 that can be angled, chamfered, U-shaped or V-shaped, rounded, etc. for operative engagement with the packing and serve the same urging purpose as the protrusion 194 shown and described in connection with the embodiment of FIGS. 1-9.

FIG. 11 illustrates another conformation of a protrusion of a packing gland 250 shown here as an angled face 252 and a generally vertical face 254 that are received in a correspondingly configured recess in the packing 256.

The arrangements of FIGS. 12-14 are more particularly useful in connection with those instances where the ball member (not shown) is inserted into packing 260 through third opening 262 which is provided in the surface of the packing opposite the opening that accommodates the actuating stem therethrough. Although perhaps not as desirable to insert the ball member into the packing through the lower surface of the packing 260 (because the lower portion of the packing is therefore enlarged and harder to insert into the open end of the valve body cavity during assembly), these embodiments exhibit other manners of modifying the valve assembly to urge the stretched packing toward its original shape and eliminate potential leak paths. For example, in FIG. 12 the wall of the valve body forming the cavity is angled at 264 (shown in exaggerated form) so that the lower portion of the packing 260 is compressed by the converging sidewall of the cavity 266 to urge the stretched packing material around the third opening 262 toward its original, unstretched shape.

In FIG. 13, the face of the packing 270 surrounding the third opening 272 is modified by inclusion of a groove 274 (in a manner similar to the upper surface groove 196 in the embodiment of FIGS. 1-7) to address the stretching issue as a result of inserting the ball member (not shown) through the third opening, and the subassembly is then inserted into the valve body cavity 276. In FIG. 14, the packing 280 is modified around the third opening 282 by including a protrusion 284 that extends outwardly from the lower surface of the packing, and thus is compressed by engagement of the packing with the end wall of the cavity 286 upon assembly. This compressed engagement between the packing and valve body urges the packing material around the third opening toward its original, unstretched shape. These alternative arrangements, of course, are illustrative only and should not be deemed to limit the present disclosure to the described embodiments.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

It is claimed:

1. A valve assembly comprising:
a housing has at least first and second flow passages that communicate with a cavity;
a valve member received in the housing cavity and adapted for selective rotation relative to the housing between open and closed positions;
a packing received around the valve member has at least first and second openings in a sidewall thereof that communicate respectively with the at least first and second flow passages in the housing, and a third opening has an original unstretched opening dimension smaller than a cross-sectional dimension of the valve member forcibly inserted through the third opening and thereby enlarges the third opening to a stretched opening dimension; and
a packing gland that operatively engages the packing, at least one of the packing gland, valve body, and packing has a non-planar surface that urges the stretched opening dimension of the third opening of the packing toward the original unstretched dimension after the valve member is assembled in the packing.

2. The valve assembly of claim 1 wherein the non-planar surface includes one of a groove and a protrusion on the packing gland.

3. The valve assembly of claim 2 wherein the packing includes the other of the groove and the protrusion that operatively cooperates with the non-planar surface of the packing gland.

4. The valve assembly of claim 1 wherein the packing gland includes a protrusion extending therefrom for engagement with the packing.

5. The valve assembly of claim 4 wherein the protrusion is around the third opening in the packing.

6. The valve assembly of claim 4 wherein the protrusion is continuous around the third opening.

7. The valve assembly of claim 4 wherein the protrusion has a generally V-shaped cross-section.

8. The valve assembly of claim 7 wherein the generally V-shaped protrusion has a rounded vertex.

9. The valve assembly of claim 1 wherein the packing is a single piece.

10. The valve assembly of claim 1 wherein the valve member includes a spherical ball portion.

11. The valve assembly of claim 10 wherein the valve member includes a stem extends outwardly through the packing, and a trunnion extending from the ball portion opposite from the stem.

12. A ball valve assembly comprising:
a body having at least first and second passages that are in fluid communication with a cavity formed in the body;
a ball valve member received in the cavity, the ball valve member has a flow passageway therethrough that selectively communicates with the passages upon rotation of the ball valve member relative to the body;
a single piece packing received in the cavity and dimensioned to receive the ball valve member therein; and
a packing gland having a protrusion extending outwardly therefrom and urged toward the single piece packing.

13. The ball valve assembly of claim 12 wherein the single piece packing includes a groove dimensioned to receive the packing gland protrusion.

14. The ball valve assembly of claim 13 wherein the packing includes an opening that receives a valve stem therethrough, the valve stem connected to the ball valve member.

15. The ball valve assembly of claim 14 wherein the packing gland protrusion operatively engages the packing around the opening.

16. The ball valve assembly of claim 15 wherein the packing gland protrusion operatively engages the packing around an entire perimeter of the opening.

17. The ball valve assembly of claim 1 wherein the packing gland is a two-part assembly.

18. The ball valve assembly of claim 1 wherein a wall of the housing cavity is angled to urge the stretched opening dimension of the third opening of the packing toward the original unstretched dimension after the valve member is assembled in the packing.

19. A method of assembling a valve assembly that includes a housing having a cavity and at least first and second flow passages that communicate therewith, a valve member rotatably received in the housing cavity, and a packing received around the valve member having first and second openings that communicate with the first and second flow passages, the assembling method comprising:
inserting the valve member into a smaller dimensioned opening in the packing whereby the packing is forcibly stretched to accommodate the valve member through the opening;
inserting the packing with valve member inserted therein into the housing cavity;
installing a gland into operative engagement with the packing around the third opening; and
providing a surface on at least one of the packing, housing, and packing gland that urges the packing smaller dimensioned opening toward its original unstretched conformation.

20. The method of claim 19 wherein the gland installing step includes providing a continuous protrusion that engages the packing around the opening.

21. The method of claim 19 further comprising providing a groove in the packing around the opening and dimensioned to receive the protrusion therein.

22. The method of claim 19 further comprising advancing the packing with the valve member inserted therein through a sizing die before inserting the packing with the inserted valve member into the housing cavity.

23. The method of claim 19 further comprising inserting the packing into the housing cavity after the ball member has been inserted in the packing.
